(19) United States
(12) Patent Application Publication
(10) Pub. No.: US 2020/0072231 A1
(43) Pub. Date: Mar. 5, 2020

(54) LUMINOUS FAN

(71) Applicant: Primax Electronics Ltd., Taipei (TW)

(72) Inventors: Wei-Chiang Huang, Taipei (TW); Ming-Hui Yeh, Taipei (TW); Wei-Ping Chan, Taipei (TW)

(21) Appl. No.: 16/192,199

(22) Filed: Nov. 15, 2018

(30) Foreign Application Priority Data
Aug. 31, 2018 (TW) 107130652

(51) Int. Cl. F04D 29/00; G06F 1/20

(52) U.S. Cl. CPC F04D 29/005; F04D 25/06; G06F 1/20

(57) ABSTRACT

A luminous fan includes a fan frame, a base portion, an illumination module and a light-guiding impeller. The light-guiding impeller is pivotally coupled to the base portion. The illumination module is disposed within a hub of the light-guiding impeller. The illumination module emits a light beam in a direction toward blades of the light-guiding impeller. Moreover, the light beam is projected to the lateral part of the hub.

### FIELD OF THE INVENTION

The present invention relates to a fan, and more particularly to a luminous fan.

### BACKGROUND OF THE INVENTION

In modern lives, desktop computers have become essential home appliances for small and medium-sized families. Generally, the host of the home computer is equipped with a cooling fan. The cooling fan is used for dissipating the heat from the casing of the host. Since the overheating problem is avoided, the processor, the motherboard or the hard drive in the host is not damaged.

For meeting the requirements or preferences of different users, a computer host with a transparent casing has been introduced into the market. The inner structure or condition within the computer host can be directly observed through the transparent casing. Moreover, the computer host may be further equipped with a luminous fan. When the computer host is turned on, the luminous fan emits a light beam. Consequently, the appearance of the computer host becomes more modern.

For example, Chinese Patent Publication No. CN 100436830C discloses a luminous fan. In the luminous fan, at least one protrusion structure is disposed on a main circuit board. A diode lamp is installed on a slant surface of the protrusion structure. Since a large-area light beam from the diode lamp is projected on the diode lamp, the fan is illuminated. However, since the light source is located at the outer side of the impeller, some drawbacks occur. For allowing the luminous fan to illuminate, the light beam has to be refracted by the blades. Due to the limitations of the irradiation area and the irradiation angle of the light source, the light utilization efficiency is still low.

For solving the drawbacks of the conventional technologies, the present invention provides a luminous fan with enhanced light utilization efficiency.

### SUMMARY OF THE INVENTION

The present invention provides a luminous fan with enhanced light utilization efficiency.

In accordance with an aspect of the present invention, there is provided a luminous fan. The luminous fan includes a fan frame, a base portion, an illumination module and a light-guiding impeller. The fan frame includes a frame body and a bracket. The bracket is located at a middle region of the frame body. The base portion is disposed on the bracket. The illumination module is disposed on the base portion. The light-guiding impeller is pivotally coupled to the base portion and rotatable relative to the base portion. The light-guiding impeller includes a hub and plural blades. The hub includes a top part and a lateral part. The lateral part is connected with the top part. The plural blades are circumferentially disposed on the lateral part. The illumination module is disposed within the hub. The illumination module emits a light beam in a direction toward the plural blades. After the light beam is projected to the lateral part of the hub, the light beam is transmitted to the plural blades through the lateral part to illuminate the light-guiding impeller.

In an embodiment, the base portion includes a main circuit board and a stator assembly. The stator assembly is installed on the main circuit board. The illumination module is installed on the main circuit board.

In an embodiment, the illumination module includes a supporting element and at least one light source unit.

In an embodiment, each of the at least one light source unit includes a flexible circuit board and at least one light-emitting chip. The at least one light-emitting chip is disposed on the flexible circuit board. The at least one light source unit is attached on a surface of the supporting element through the flexible circuit board.

In an embodiment, the supporting element is a supporting plate or a ring-shaped supporting structure.

In an embodiment, the hub further includes a ring-shaped inner wall, which is disposed within the hub and installed on the top part of the hub. An inner space of the hub is divided into a first accommodation space and a second accommodation space by the ring-shaped inner wall.

In an embodiment, the stator assembly is disposed within the first accommodation space.

In an embodiment, the illumination module is disposed within the second accommodation space.

In an embodiment, a sheltering layer is formed on a surface of the light-guiding impeller, and a region of the light-guiding impeller uncovered by the sheltering layer is formed as at least one light-transmissible part.

In an embodiment, the at least one light-transmissible part is formed on the top part of the hub.

In an embodiment, the at least one light-transmissible part is formed on at least one of the plural blades.

In an embodiment, at least one of the plural blades includes a light extraction part.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1A is a schematic exploded view illustrating a luminous fan according to a first embodiment of the present invention;

FIG. 1B is a schematic top view illustrating the luminous fan according to the first embodiment of the present invention;

FIG. 1C is a schematic cross-sectional view illustrating the luminous fan according to the first embodiment of the present invention;

FIG. 2 schematically illustrates an illuminating condition of the luminous fan according to the first embodiment of the present invention;

FIG. 3 schematically illustrates a variant example of an illuminating condition of the luminous fan according to the first embodiment of the present invention;

FIG. 4A schematically illustrates another variant example of an illuminating condition of the luminous fan according to the first embodiment of the present invention;

FIGS. 4B and 4C are schematic enlarged sides view illustrating two examples of the light extraction part in the luminous fan of FIG. 4A;

FIG. 5A is a schematic exploded view illustrating a luminous fan according to a second embodiment of the present invention; and

FIG. 5B is a schematic top view illustrating the luminous fan according to the second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

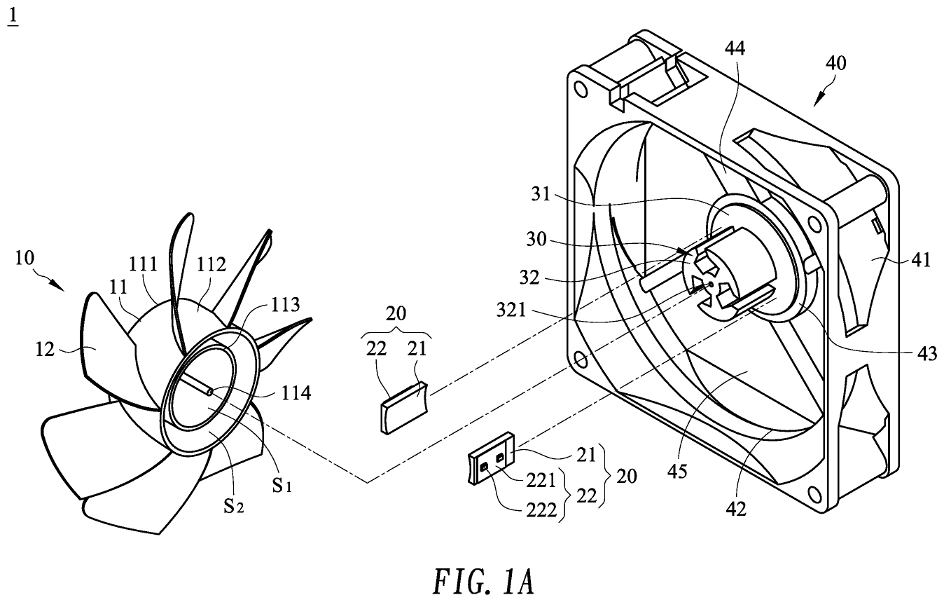

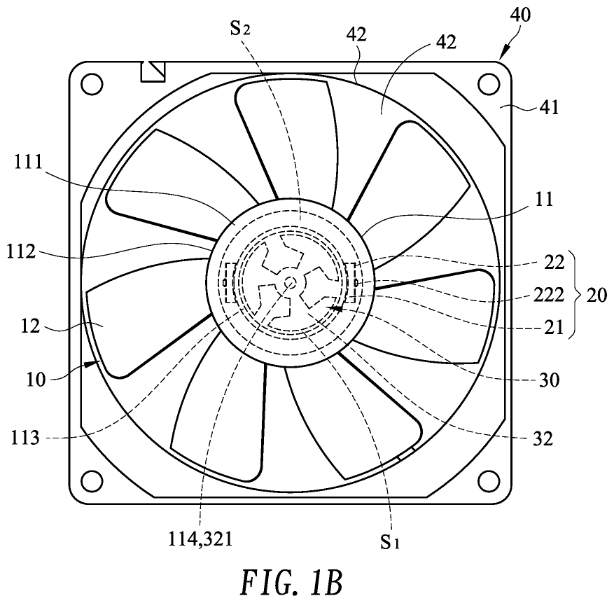

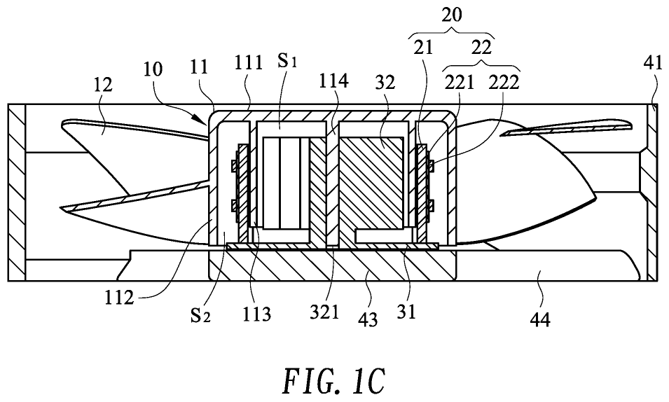

Please refer to FIG. 1A. FIG. 1A is a schematic exploded view illustrating a luminous fan according to a first embodiment of the present invention. As shown in FIG. 1A, the luminous fan 1 comprises a light-guiding impeller 10, an illumination module 20, a base portion 30 and a fan frame 40.

The light-guiding impeller 10 comprises a hub 11 and plural blades 12. The hub 11 comprises a top part 111 and a lateral part 112. The lateral part 112 is connected with the top part 111. The blades 12 are circumferentially disposed on a surface of the lateral part 112. A ring-shaped inner wall 113 is disposed within the hub 11. The ring-shaped inner wall 113 is installed on the top part 111 of the hub 11. By the ring-shaped inner wall 113, the inner space of the hub 11 is divided into a first accommodation space S1 and a second accommodation space S2. The second accommodation space S2 is arranged around the first accommodation space S1. A rotation shaft 114 is disposed within the first accommodation space S1 and connected with the top part 111 of the hub 11. In an embodiment, light-guiding impeller 10 is made of light-transmissible/light-guiding material such as polycarbonate (PC) or acrylic resin. In another embodiment, diffusion powder or phosphor powder is added and mixed with the light-transmissible/light-guiding material during the process of fabricating the light-guiding impeller 10. Consequently, the light-guiding efficacy or the illuminating efficacy of the light-guiding impeller 10 is increased.

The illumination module 20 comprises a supporting element 21 and at least one light source unit 22. The light source unit 22 comprises a flexible circuit board 221 and at least one light-emitting chip 222. The at least one light-emitting chip 222 is disposed on the flexible circuit board 221. For example, the light-emitting chip 222 is a light emitting diode (LED) chip or an electroluminescence (EL) chip. For example, the supporting element 21 is a supporting plate. The light source unit 22 is attached on a surface of the supporting element 21 through the flexible circuit board 221.

The base portion 30 comprises a main circuit board 31 and a stator assembly 32. The stator assembly 32 is installed on the main circuit board 31. Moreover, a pivotal hole 321 is formed in a middle region of the stator assembly 32 and aligned with the rotation shaft 114.

The fan frame 40 comprises a frame body 41, a receiving recess 42, a bracket 43, plural ribs 44 and plural ventilation holes 45. The rotation shaft 114 is accommodated within the receiving recess 42. The bracket 43 is located at a middle region of the frame body 41 and disposed within the receiving recess 42. The bracket 43 is connected with the frame body 41 through the plural ribs 44. The plural ventilation holes 45 are formed in the receiving recess 42.

Please refer to FIGS. 1B and 1C. FIG. 1B is a schematic top view illustrating the luminous fan according to the first embodiment of the present invention. FIG. 1C is a schematic cross-sectional view illustrating the luminous fan according to the first embodiment of the present invention. As shown in FIGS. 1B and 1C, the rotation shaft 114 of the light-guiding impeller 10 is penetrated through the pivotal hole 321 and connected with a bearing (not shown) within the pivotal hole 321. Consequently, the light-guiding impeller 10 is pivotally coupled to the base portion 30 and rotatable relative to the base portion 30. The stator assembly 32 is disposed within the first accommodation space S1 of the hub 11 and aligned with a rotator assembly (not shown), which is installed on the ring-shaped inner wall 113. The illumination module 20 is installed on the main circuit board 31 and disposed within the second accommodation space S2. The second accommodation space S2 is arranged between the lateral part 112 of the hub 11 and the ring-shaped inner wall 113. Moreover, the light source unit 22 faces the lateral part 112 of the hub 11. Consequently, the illumination module 20 emits a light beam in a direction toward the blades 12. Moreover, the main circuit board 31 provides electricity to the illumination module 20 and the stator assembly 32 and controls the illumination module 20 to emit the light beam to the lateral part 112 of the hub 11. The main circuit board 31 further controls the power level of the stator assembly 32 in order to adjust the rotating speed of the light-guiding impeller 10.

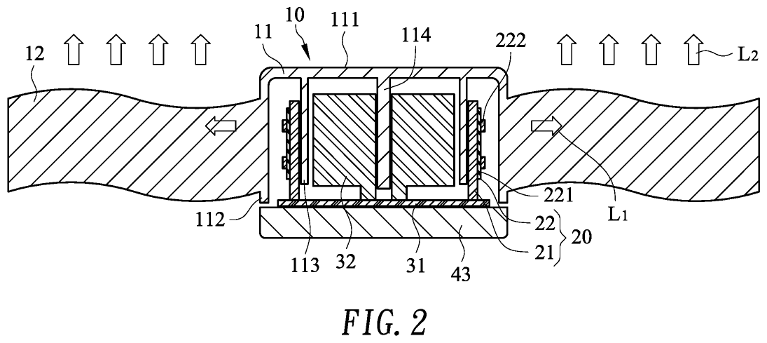

FIG. 2 schematically illustrates an illuminating condition of the luminous fan according to the first embodiment of the present invention. As shown in FIG. 2, the light source unit 22 of the illumination module 20 faces the lateral part 112 of the hub 11 and the light source unit 22 emits the light beam L1 in the direction toward the blades 12. Consequently, when the light beam L1 from the light source unit 22 is projected to the lateral part 112 of the hub 11, the light beam L1 is completely received by the inner surface of the lateral part 112 of the hub 11. Moreover, since the illumination module 20 emits the light beam L1 in the direction toward the blades 12, the light beam L1 can be transmitted to the blades 12 without so many reflections. After the light beam L1 is reflected and refracted by the blades 12, a resulting light beam L2 is outputted from the blades 12. Consequently, the illuminating function of the luminous fan is achieved.

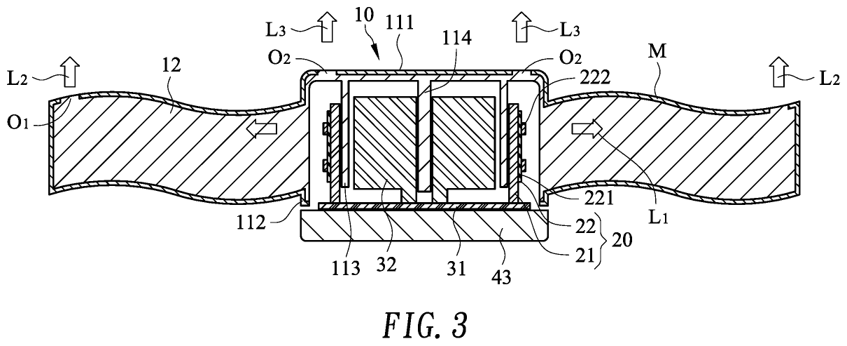

FIG. 3 schematically illustrates a variant example of an illuminating condition of the luminous fan according to the first embodiment of the present invention. The components of the luminous fan of FIG. 3 that are similar to those of FIG. 2 are not redundantly described herein. In comparison with FIG. 2, a sheltering layer M is formed on a surface of the light-guiding impeller 10. The sheltering layer M is used for sheltering the light beam. Moreover, the region of the light-guiding impeller 10 uncovered by the sheltering layer M is a light-transmissible part. For example, a first light-transmissible part O1 is formed on the surface of the blades 12, or a second light-transmissible part O2 is formed on a top surface of the top part 111 of the hub 11. After the light beam L1 from the light source unit 22 is projected to the lateral part 112 of the hub 11, the light beam L1 is reflected and refracted by the lateral part 112 of the hub 11. Consequently, a resulting light beam L3 is outputted from the second light-transmissible part O2. Moreover, after the light beam L1 is transmitted to the blades 12 through the lateral part 112 of the hub 11, the light beam L1 is reflected and refracted by the blades 12. Consequently, a resulting light beam L2 is outputted from the first light-transmissible part O1. In an embodiment, the sheltering layer M is made of opaque or translucent ink, paint or sticker. Moreover, the size, position and shape of the light-transmissible part may be adjusted according to the practical requirements. Consequently, the illuminated position or the luminous pattern can be correspondingly adjusted.

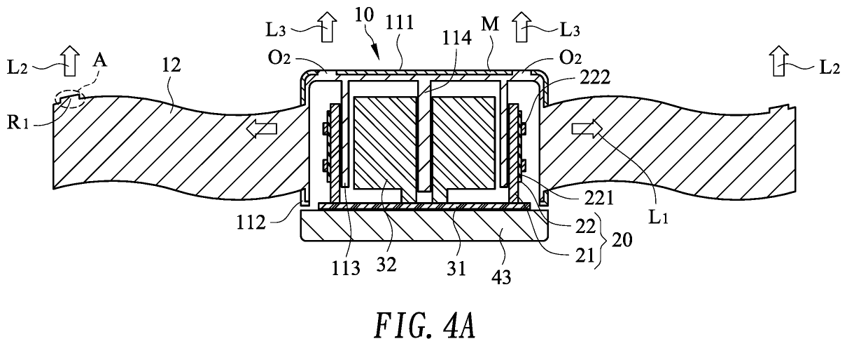

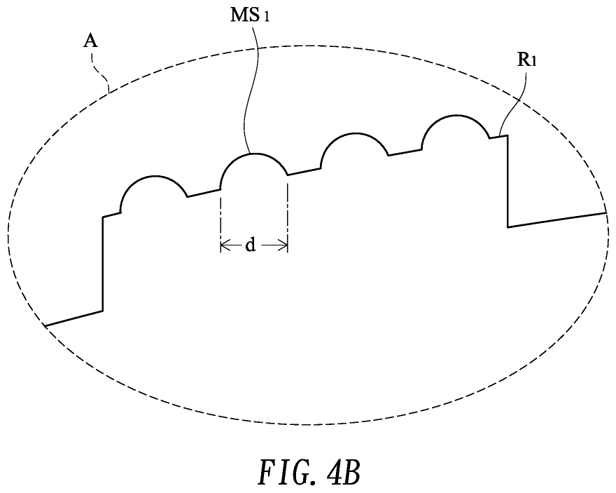

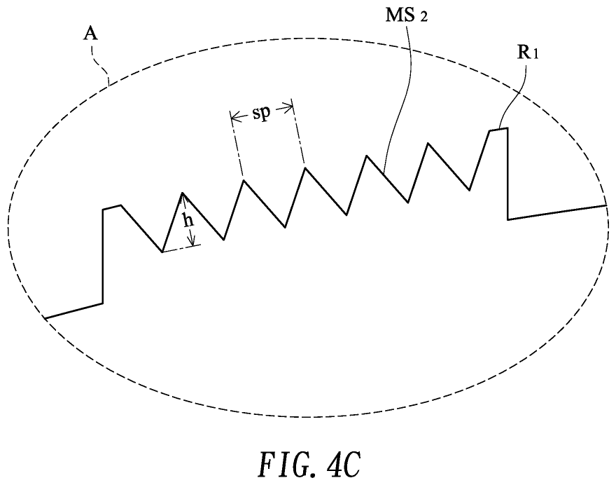

FIG. 4A schematically illustrates another variant example of an illuminating condition of the luminous fan according to the first embodiment of the present invention. The components of the luminous fan of FIG. 4A that are similar to those of FIG. 3 are not redundantly described herein. In comparison with FIG. 3, the surface of the blade 12 further comprises a light extraction part R1. After the light beam L1 from the light source unit 22 is projected to the lateral part 112 of the hub 11, the light beam L1 is reflected and refracted by the lateral part 112 of the hub 11. Consequently, a resulting light beam L3 is outputted from the second light-transmissible part O2. Moreover, after the light beam L1 is transmitted to the blades 12 through the lateral part 112 of the hub 11, the light beam L1 is reflected and refracted by the blades 12. Consequently, a resulting light beam L2 is outputted from the light extraction part R1.

Please refer to FIGS. 4A, 4B and 4C. FIGS. 4B and 4C are schematic enlarged sides view illustrating two examples of the light extraction part in the luminous fan of FIG. 4A. The first example of the light extraction part R1 is shown in FIG. 4B. The second example of the light extraction part R1 is shown in FIG. 4C.

Please refer to FIG. 4B. The surface of the light extraction part R1 has plural hemisphere-shaped light extraction structures MS1. The diameter d of each light extraction structure MS1 is about 40 μm. Please refer to FIG. 4C. The surface of the light extraction part R1 has plural prism-shaped light extraction structures MS2. The pitch sp between the peaks of every two adjacent light extraction structures MS2 is about 18 μm. The vertical distance h between the peak and the valley is about 15 μm. After the light beam L1 is reflected and refracted by the blades 12, the resulting light beam L2 is outputted from the light extraction part R1. Since the refraction of the light extraction structures MS1 or MS2 increases the light extraction efficiency, the luminance of the light beam L2 is increased.

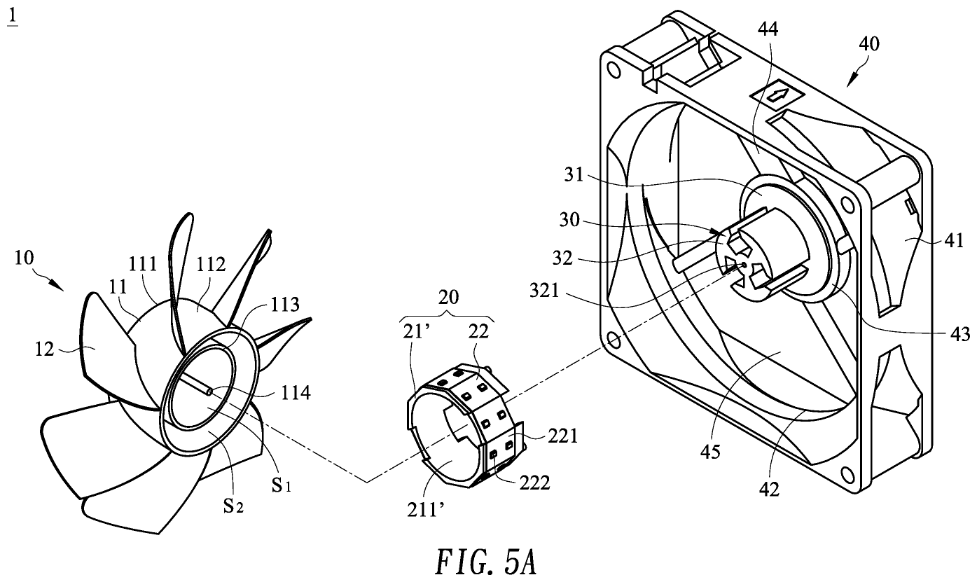

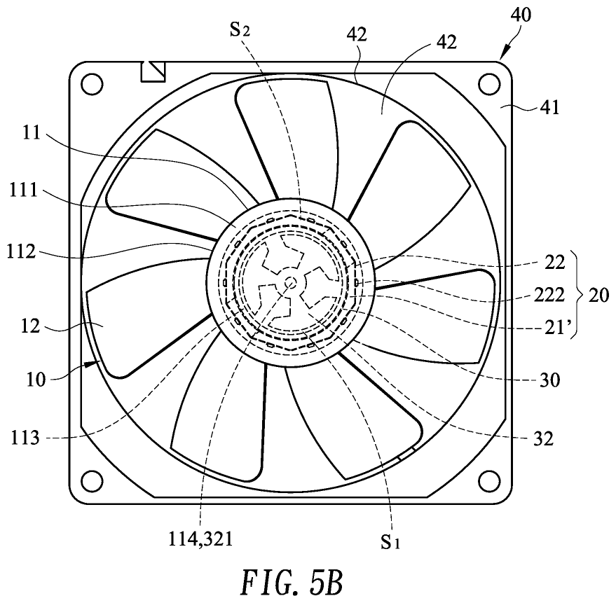

Please refer to FIGS. 5A and 5B. FIG. 5A is a schematic exploded view illustrating a luminous fan according to a second embodiment of the present invention. FIG. 5B is a schematic top view illustrating the luminous fan according to the second embodiment of the present invention. The components of the luminous fan of FIGS. 5A and 5B that are similar to those of FIGS. 1A and 1B are not redundantly described herein. In comparison with the first embodiment, the supporting element 21′ of the illumination module 20 is a ring-shaped supporting structure with an opening 211′. The ring-shaped inner wall 113 of the hub 11 is disposed within the opening 211′. Moreover, plural light source units 22 are attached on a surface of the supporting element 21′ through the flexible circuit board 221. Consequently, the beam angle of the light beam from the illumination module 20 is 360 degrees.

From the above descriptions, the present invention provides a luminous fan. The light source unit is attached on the surface of the supporting element with various structures through the flexible circuit board. Consequently, the flexibility of fabricating the illumination module is increased. Moreover, when the light beam from the illumination module is projected to the lateral part of the hub, the light beam is completely received by the inner surface of the lateral part of the hub. Moreover, since the illumination module emits the light beam in the direction toward the blades, the light beam can be transmitted to the blades without so many reflections. Consequently, the overall light utilization efficiency of the luminous fan is effectively enhanced. In other words, the luminous of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A luminous fan, comprising:
a fan frame comprising a frame body and a bracket, wherein the bracket is located at a middle region of the frame body;
a base portion disposed on the bracket;
an illumination module disposed on the base portion; and
a light-guiding impeller pivotally coupled to the base portion and rotatable relative to the base portion, and comprises a hub and plural blades, wherein the hub comprises a top part and a lateral part, the lateral part is connected with the top part, and the plural blades are circumferentially disposed on the lateral part,
wherein the illumination module is disposed within the hub, and the illumination module emits a light beam in a direction toward the plural blades, wherein after the light beam is projected to the lateral part of the hub, the light beam is transmitted to the plural blades through the lateral part to illuminate the light-guiding impeller.

2. The luminous fan according to claim 1, wherein the base portion comprises a main circuit board and a stator assembly, wherein the stator assembly is installed on the main circuit board, and the illumination module is installed on the main circuit board.

3. The luminous fan according to claim 1, wherein the illumination module comprises a supporting element and at least one light source unit.

4. The luminous fan according to claim 3, wherein each of the at least one light source unit comprises a flexible circuit board and at least one light-emitting chip, wherein the at least one light-emitting chip is disposed on the flexible circuit board, and the at least one light source unit is attached on a surface of the supporting element through the flexible circuit board.

5. The luminous fan according to claim 3, wherein the supporting element is a supporting plate or a ring-shaped supporting structure.

6. The luminous fan according to claim 2, wherein the hub further comprises a ring-shaped inner wall, which is disposed within the hub and installed on the top part of the hub, wherein an inner space of the hub is divided into a first accommodation space and a second accommodation space by the ring-shaped inner wall.

7. The luminous fan according to claim 6, wherein the stator assembly is disposed within the first accommodation space.

8. The luminous fan according to claim 6, wherein the illumination module is disposed within the second accommodation space.

9. The luminous fan according to claim 1, wherein a sheltering layer is formed on a surface of the light-guiding impeller, and a region of the light-guiding impeller uncovered by the sheltering layer is formed as at least one light-transmissible part.

10. The luminous fan according to claim 9, wherein the at least one light-transmissible part is formed on the top part of the hub.

11. The luminous fan according to claim 9, wherein the at least one light-transmissible part is formed on at least one of the plural blades.

12. The luminous fan according to claim 1, wherein at least one of the plural blades comprises a light extraction part.
